(19) United States
(12) Patent Application Publication
(10) Pub. No.: US 2025/0078432 A1
(43) Pub. Date: Mar. 6, 2025

(54) MODEL MODIFICATION METHOD, APPARATUS, ELECTRONIC DEVICE AND READABLE STORAGE MEDIUM

(71) Applicant: LUXSHARE PRECISION INDUSTRY COMPANY LIMITED, Shenzhen (CN)

(72) Inventor: Jianqiu LIN, Shenzhen (CN)

(73) Assignee: LUXSHARE PRECISION INDUSTRY COMPANY LIMITED, Shenzhen (CN)

(21) Appl. No.: 18/733,605

(22) Filed: Jun. 4, 2024

(30) Foreign Application Priority Data
Aug. 29, 2023 (CN) 202311101748.6

(51) Int. Cl. G06T 19/20; G06T 17/20

(52) U.S. Cl. CPC G06T 19/20; G06T 17/20; G06T 2219/2008

(57) ABSTRACT

Disclosed are a model modification method and apparatus, an electronic device and a readable storage medium. The model modification method includes: determining similar features corresponding to target volume grids in a target model, wherein each of the similar features is comprised in the corresponding target volume grid; selecting volume grids associated with the similar features in the target model to obtain a volume grid set, wherein the volume grid set comprises the target volume grids; and receiving an operation instruction, and executing modification operation corresponding to the operation instruction on the target volume grids in the volume grid set to update the target model.

### CROSS-REFERENCE OF RELATED APPLICATIONS

The present disclosure claims all the benefits of Chinese Patent Application No. 202311101748.6 filed on Aug. 29, 2023 before the China National Intellectual Property Administration of the People's Republic of China, entitled “Model Modification Method, Apparatus, Electronic Device And Readable Storage Medium”, which is incorporated herein by reference in its entirety.

### FIELD

The present disclosure generally relates to the field of modeling, in particular to a model modification method, apparatus, electronic device and readable storage medium.

### BACKGROUND

A hexahedral grid unit is a common unit in simulation grid modeling and is used in grid division of most components. Regarding components with complex shapes, the number of generated grids is huge, so modifying specific area grids requires a lot of work. If a single grid is selected one by one, single operation needs to be repeated, which is inefficient; if box selection is used, it is easy to mistakenly select grids that do not need to be selected, which is inconvenient and leads to inconvenience in modifying specific grids.

### SUMMARY

In an aspect, the disclosure provides a model modification method comprising:
determining similar features corresponding to target volume grids in a target model, wherein each of the similar features is comprised in the corresponding target volume grid;
selecting volume grids associated with the similar features in the target model to obtain a volume grid set, wherein the volume grid set comprises the target volume grids; and
receiving an operation instruction, and executing modification operation corresponding to the operation instruction on the target volume grids in the volume grid set to update the target model.

In some embodiments, determining similar features corresponding to target volume grids in a target model comprises:
performing feature generating operation on the target model to generate optional features corresponding to the similar features;
acquiring preset selection instructions and determining selection conditions of the preset selection instructions;
determining matching features corresponding to the selection conditions among the optional features for each of the preset selection instructions;
determining a target selection instruction in the preset selection instructions according to the matching features corresponding to the selection conditions; and
executing the target selection instruction to take matching features corresponding to the target volume grids as the similar features.

In some embodiments, determining a target selection instruction in the preset selection instructions according to the matching features corresponding to the selection conditions comprises:
determining matching volume grids corresponding to the matching features for each of the preset selection instructions;
determining whether the matching volume grid is equivalent to the target volume grid for each of the preset selection instructions; and
when the matching volume grid is equivalent to the target volume grid, taking the preset selection instruction as the target selection instruction.

In some embodiments, after determining whether the matching volume grid is equivalent to the target volume grid, the model modification method comprises:
when the matching volume grid comprises the non-target volume grid, taking the preset selection instruction as a non-selection instruction which cannot be selected as the target selection instruction.

In some embodiments, after determining whether the matching volume grid is equivalent to the target volume grid, the model modification method comprises:
when the matching volume grid is properly included in the target volume grid, taking the preset selection instruction as a first instruction;
determining a second instruction in the preset selection instruction according to the matching features corresponding to the selection conditions, wherein a set of matching volume grids corresponding to the second instruction and matching volume grids corresponding to the first instruction is equivalent to a set of the target volume grids; and
taking the first instruction and the second instruction as the target selection instruction.

In some embodiments, determining a second instruction in the preset selection instructions according to the matching features corresponding to the selection conditions comprises: when there is no preset selection instruction comprising all target volume grids not corresponding to the first instruction, determining a plurality of second instructions, so that a set of matching volume grids corresponding to a plurality of the second instructions and the matching volume grids corresponding to the first instruction is equivalent to the set of the target volume grids.

In some embodiments, the target model is a tubular model, the target volume grid is an outer surface volume grid, and determining similar features corresponding to the target volume grid in a target model comprises:
taking a surface grid on the outer surface of the tubular model as the similar features corresponding to the outer surface volume grid; and
selecting volume grids associated with the similar features in the target model to obtain a volume grid set comprises:
selecting volume grids where the outer surface volume grids are located to obtain the volume grid set.

In some embodiments, selecting volume grids associated with the similar features in the target model to obtain a volume grid set comprises:
determining volume grids where the similar features are located for each of the similar features; and
selecting all the volume grids to obtain the volume grid set.

In some embodiments, the operation instruction comprises a delete instruction, a copy instruction and a move instruction, and executing modification operation corresponding to the operation instruction on the target volume grids in the volume grid set comprises:
deleting, copying or moving the volume grids comprised in the volume grid set.

In another aspect, the disclosure further provides a model modification apparatus, which comprises:
a first determination module configured to determine similar features corresponding to target volume grids in a target model, wherein each of the similar features is comprised in the corresponding target volume grid;
a first selection module configured to select volume grids associated with the similar features in the target model to obtain a volume grid set, wherein the volume grid set comprises the target volume grids; and
a first receiving module configured to receive operation instructions and execute modification operation corresponding to the operation instructions on the target volume grids in the volume grid set to update the target model.

In yet another aspect, the disclosure further provides an electronic device comprising a memory, a processor, and a computer program stored on the memory and capable of running on the processor, wherein the computer program implements the model modification method of the disclosure when executed by the processor.

In still another aspect, the disclosure further provides a readable storage medium on which a computer program is stored, wherein the computer program implements the model modification method of the disclosure when executed by a processor.

In some embodiments, the similar features of the target volume grids are determined, so that the target volume grid can be located in the target model based on the similar feature, and then the target volume grid can be selected conveniently, thus solving a problem of inconvenient grid selection, and performing related operation on the volume grid set improves efficiency of modifying grids in a specific area.

### BRIEF DESCRIPTION OF DRAWINGS

Accompanying drawings herein are incorporated in the description and constitute a part of the description, illustrate embodiments according to the disclosure, and explain the principle of the disclosure together with the description.

In order to more clearly illustrate embodiments of the disclosure, drawings that need to be used in description of the embodiments are briefly introduced below, and it will be apparent to those of ordinary skill in the art that other drawings can be obtained based on these drawings without inventive work.

FIG. 1 is a flow chart of an embodiment of a model modification method of the present disclosure;

FIG. 2 is a diagram in which a model modification method according to an embodiment of the present disclosure is applied to a tubular model;

FIG. 3 is a structure diagram of an electronic device according to an embodiment of the present disclosure; and

FIG. 4 is a structure diagram of a model modification apparatus according to an embodiment of the present disclosure.

### DETAILED DESCRIPTION

It should be understood that specific embodiments described herein are only used to explain the disclosure but not limit the disclosure. In order that those skilled in the art better understand the solution of the present disclosure, technical solutions in embodiments of the present disclosure will be clearly and fully described in combination with the accompanying drawings in the embodiments of the present disclosure. Obviously, the embodiments to be described are merely part of embodiments of the present disclosure, but not all embodiments of the present disclosure. Based on the embodiments in the disclosure, all other embodiments obtained by those of ordinary skill in the art without inventive work shall fall within the scope of the disclosure.

The present disclosure provides a model modification method. With reference to FIG. 1, FIG. 1 is a flow chart of an embodiment of a model modification method of the present disclosure, the method including:

Step S10, determining similar features corresponding to target volume grids in a target model, wherein each of the similar features is included in the corresponding target volume grid;

Step S20, selecting volume grids associated with the similar features in the target model to obtain a volume grid set, wherein the volume grid set includes the target volume grids; and

Step S30, receiving operation instructions, and executing modification operation corresponding to the operation instructions on the target volume grids in the volume grid set to update the target model.

In some embodiments, the target model is an object that needs to be modified at present. It can be understood that specific structures of the target model are different based on different practical application scenarios.

In some embodiments, the target volume grid is a volume grid that needs to be selected from the target model. The type of the volume grid can be set based on actual needs. In some embodiments, the volume grid may be a tetrahedral grid or a hexahedral grid. Taking the hexahedral grid as an example in this embodiment and subsequent embodiments, other types of volume grids can be implemented analogously, which are not repeated.

Similar features are used to indicate feature contents with the same attributes in the target volume grids. It can be understood that since the similar features corresponding to the target volume grids have the same attributes, the similar features in the target model can be determined by corresponding tools without manual selection.

Since the similar features correspond to the target volume grid, the target volume grid in the target model can be determined by the similar features. In some embodiments, the volume grid associated with the similar features indicates the target volume grid corresponding to similar features, and the volume grid associated with the similar features may be a volume grid with the similar features, a volume grid in contact with the volume grid, or a volume grid with specific conditions set. A set of the target volume grids constitutes a volume grid set, so the volume grid set contains the target volume grids. It can be understood that the target volume grid is a volume grid that needs to be selected, while the volume grid except the target volume grid in the target model is a volume grid that does not need to be selected. Therefore, the volume grid set should contain all the target volume grids and only the target volume grids.

The operation instruction is used to indicate modification operation on the target volume grids. Based on specific operations that need to be performed, the corresponding operation instructions are different. In some embodiments, the operation instructions include, but are not limited to, move instructions, copy instructions, and delete instructions. In some embodiments, the modification operation corresponding to the move instructions is to perform move operation on the target volume grids. In some embodiments, the modification operation corresponding to the copy instructions is to perform copy operation on the target volume grids. In some embodiments, the modification operation corresponding to the delete instructions is to perform delete operation on the target volume grids. In some embodiments, the corresponding modification operation is performed on the target volume grids based on the operation instructions to update the target model.

In this embodiment, the similar features of the target volume grids are determined, so that the target volume grid can be located in the target model based on the similar feature, and then the target volume grid can be selected conveniently, thus solving a problem of inconvenient grid selection, and performing related operation on the volume grid set improves efficiency of modifying grids in a specific area.

In some embodiments, Step S10 includes:
Step S11, performing feature generating operation on the target model to generate optional features corresponding to the similar features;
Step S12, acquiring preset selection instructions and determining selection conditions of the preset selection instructions;
Step S13, determining matching features corresponding to the selection conditions among the optional features for each of the preset selection instructions;
Step S14, determining a target selection instruction in the preset selection instructions according to the matching features corresponding to the selection conditions; and
Step S15, executing the target selection instruction to use the matching features corresponding to the target volume grids as the similar features.

In some embodiments, the optional features are all features in the target model with the same type as the similar features. If the type of the similar features is a surface grid of an outer surface of the target model, the optional features are the surface grid of the target model.

It can be understood that for the target model, features with the same type as the similar features are not necessarily set. For example, when the most basic unit of the target model is a volume grid, there is no surface grid in the target model, so it is impossible to match the similar features with the type of a surface grid. Therefore, it is necessary to generate the surface grid in the target model before matching the similar features.

The feature generating operation is configured to generate optional features. It can be understood that the feature generating operation is determined based on the type of similar features. For example, when the type of the similar features are surface grids on the outer surface of the target model, the corresponding feature generating operation is to generate surface grids on the surface of the target model. In some embodiments, a find face instruction is executed after selecting the target model, and a plurality of surface grids that constitute the target model surface can be generated.

A preset selection instruction is a preset instruction for batch selection of elements in the model. Based on different modeling software or plug-ins, settings of the preset selection instructions are different. In some embodiments, taking a hypermesh software as an example, the preset selection instructions include but are not limited to by face and by attached. The selection conditions are the basis on which the preset selection instructions select grids. For example, selection conditions corresponding to the by face instruction are on the same surface as the selected element; selection conditions corresponding to the by attached instruction is to connect with selected element nodes.

The matching feature is a feature element selected when the target model executes the preset selection instructions; the matching feature corresponding to the byface instruction is an element on the same surface as the selected element in the target model; the matching feature corresponding to the by attached instruction is an element connected to the selected element node in the target model.

The matching feature reflects a selection state of elements in the target model by the preset selection instruction. Therefore, a selection matching degree of the target volume grid by different preset selection instructions can be compared through the matching feature, so as to determine the final target selection instruction and then select similar features by executing the target selection instruction.

In some embodiments, Step S14 includes:
Step S141, determining matching volume grids corresponding to the matching features for each of the preset selection instructions;
Step S142, determining whether the matching volume grid is equivalent to the target volume grid for each of the preset selection instructions; and
Step S143, taking the preset selection instruction as the target selection instruction if the matching volume grid is equivalent to the target volume grid.

The matching volume grid is a volume grid where the matching features are located. In some embodiments, the matching volume grid being equivalent to the target volume grid means that the target volume grid can be completely selected by executing the preset selection instruction and the non-target volume grid is not selected, so the preset selection instruction is taken as the target selection instruction. It should be noted that when the matching volume grid corresponding to a plurality of preset selection instructions is equivalent to the target volume grid, one of the preset selection instructions is set as the target selection instruction randomly or based on preset priority.

When the matching volume grid is not equivalent to the target volume grid, there are two situations: one is that the matching volume grid includes a non-target volume grid; the other is that the matching volume grid includes part of the target volume grid and does not include the non-target volume grid, that is, the matching volume grid is properly included in the target volume grid.

If the matching volume grid includes a non-target volume grid, the corresponding preset selection instruction will be wrongly selected. Therefore, the preset selection instruction is taken as a non-selection instruction which cannot be selected as the target selection instruction.

In some embodiments, after Step S142, Step S14 includes:
Step S144, taking the preset selection instruction as a first instruction if the matching volume grid is properly included in the target volume grid;
Step S145, determining a second instruction in the preset selection instruction according to the matching features corresponding to the selection conditions, wherein a set of matching volume grids corresponding to the second instruction and matching volume grids corresponding to the first instruction is equivalent to a set of the target volume grids; and
Step S146, taking the first instruction and the second instruction as the target selection instruction.

If the matching volume grid is properly included in the target volume grid, the similar features corresponding to the complete target volume grids can be selected by combining a plurality of the preset selection instructions.

The first instruction and the second instruction are both preset selection instructions corresponding to the matching volume grid being properly included in the target volume grid. In some embodiments, a determination method of the first instruction and the second instruction can be set based on the actual application needs. In some embodiments, a preset selection instruction in which the matching volume grid is properly included in the target volume grid and the largest number of target volume grids are included is taken as the first instruction, and on the basis of selection of the first instruction, a preset selection instruction that includes all the target volume grids not corresponding to the first instruction is taken as the second instruction. At this time, the set of matching volume grids corresponding to the first instruction and the second instruction is equivalent to the set of target volume grids. It should be noted that the set of the matching volume grids corresponding to the second instruction and the matching volume grids corresponding to the first instruction does not contain duplicate volume grids.

On the basis of the determination of the first instruction, if there is no preset selection instruction containing all the target volume grids not corresponding to the first instruction, a plurality of second instructions can be determined, so that a set of matching volume grids corresponding to a plurality of the second instructions and the matching volume grids corresponding to the first instruction is equivalent to the set of target volume grids. A specific determination method of a plurality of the second instructions can analogize the determination method of the first instruction and the second instruction.

This embodiment can accurately determine the similar features corresponding to the target volume grid.

In some embodiments, the target model is a tubular model, and the target volume grid is an outer surface volume grid. Step S10 includes:
Step S16, taking the surface grid on the outer surface of the tubular model as the similar feature corresponding to the outer surface volume grid; and
Step S20 includes:
Step S21, selecting the volume grids where the outer surface volume grids are located to obtain the volume grid set.

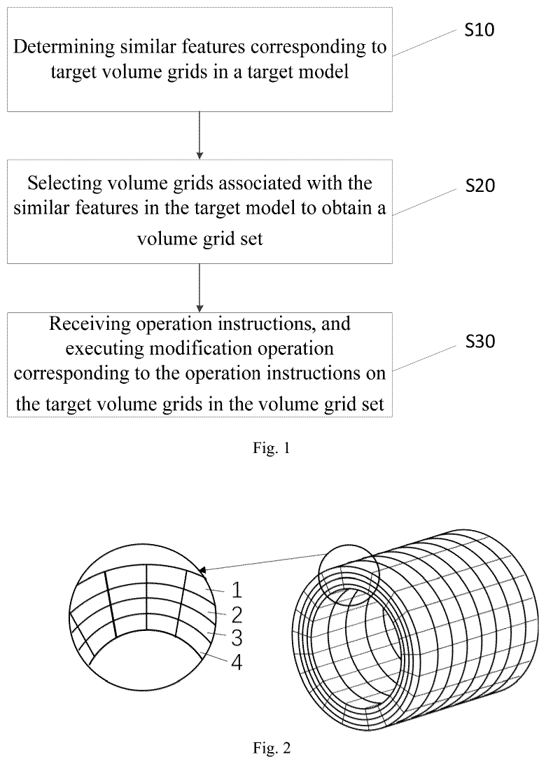

Refer to FIG. 2, a sub-pipeline of 1 is the outer surface volume grids of the tubular model, a sub-pipeline of 4 is inner surface volume grids of the tubular model, and sub-pipelines of 2 and 3 are middle volume grids of the tubular model. When different thickness schemes of the tubular model need to be verified, it is necessary to delete the outer surface volume grid of the model, that is, one unit thickness of the volume grid included in the sub-pipeline of 1 in the drawing, and the similar features corresponding to the outer surface volume grid are surface grids in the outer surface of the tubular model. At this time, all the surface grids of the outer surface can be selected and the similar features of the outer surface volume grid can be determined by selecting any surface grid in the outer surface of the tubular model and executing the by face instruction. After all the surface grids of the outer surface are selected, the volume grid adjacent to the selected surface grids is associated. It can be understood that all the surface grids of the outer surface are only adjacent to the inner volume grid, so selecting the volume grid adjacent to the surface grids can completely select the outer surface volume grid, and meanwhile will not select volume grids other than the outer surface volume grid. After selected, the outer surface volume grid, that is, the volume grid included in the sub-pipeline of 1 can be deleted.

In some embodiments, when it is necessary to delete the outer surface volume grid and the inner surface volume grid of the tubular model, that is, the volume grids included in the sub-pipelines where 1 and 4 are located in the drawings by one unit thickness at the same time, all the surface grids in the outer surface of the tubular model can be selected by selecting any surface grid in the outer surface and executing the by face instruction (first instruction), and all the surface grids in the inner surface of the tubular model can be selected by selecting any surface grid in the inner surface and executing the by face instruction (second instruction), thereby determining the similar features of the inner and outer surface volume grids. Then, the inner and outer surface grids are deleted analogously to the above operation.

For the sake of simple description, all the above method embodiments are expressed as a series of action combinations, but those skilled in the art should know that the disclosure is not limited by the described action sequence, because some steps can be performed in other sequences or simultaneously according to the disclosure. Secondly, those skilled in the art should also know that the embodiments described in the description are all exemplary embodiments, and actions and modules involved are not necessarily required by the disclosure.

Through description of the above embodiments, those skilled in the art can clearly understand that the method according to the above embodiments can be realized by means of software and a necessary general hardware platform, and of course by means of hardware. Based on such understanding, the technical solution of the disclosure can be embodied in the form of a software product which is stored in a storage medium (such as ROM/RAM, magnetic disk and optical disk) and includes several instructions to cause a terminal device (which can be a mobile phone, a computer, a server, a network device, or the like) to execute the method described in the embodiments of the disclosure.

As shown in FIG. 4, the present disclosure further provides a model modification device 100 configured to implement the model modification method of the present disclosure, which includes:
a first determination module 110 configured to determine similar features corresponding to target volume grids in a target model, wherein each of the similar features is included in the corresponding target volume grid;
a first selection module 120 configured to select volume grids associated with the similar features in the target model to obtain a volume grid set, wherein the volume grid set includes the target volume grids; and
a first receiving module 130 configured to receive operation instructions and execute modification operation corresponding to the operation instructions on the target volume grids in the volume grid set to update the target model.

In the model modification device, the similar features of the target volume grids are determined, so that the target volume grid can be located in the target model based on the similar feature, and then the target volume grid can be selected conveniently, thus solving a problem of inconvenient grid selection, and performing related operation on the volume grid set improves efficiency of modifying grids in a specific area.

In some embodiments, the first determination module 110 may be configured to perform the Step S10 of the present disclosure. In some embodiments, the first selection module 120 may be configured to perform the Step S20 of the present disclosure. In some embodiments, the first receiving module 130 may be configured to perform the Step S30 of the present disclosure.

In some embodiments, the first determination module includes:
a first generation unit configured to perform feature generating operation on the target model to generate optional features corresponding to the similar features;
a first acquisition unit configured to acquire preset selection instructions and determine selection conditions of the preset selection instructions;
a first determination unit configured to determine matching features corresponding to the selection conditions among the optional features for each of the preset selection instructions;
a second determination unit configured to determine a target selection instruction in the preset selection instructions according to the matching features corresponding to the selection conditions; and
a first execution unit configured to execute the target selection instruction to use the matching features corresponding to the target volume grids as the similar features.

In some embodiments, the second determination unit includes:
a first determination subunit configured to determine matching volume grids corresponding to the matching features for each of the preset selection instructions;
a first judgement subunit configured to judge whether the matching volume grid is equivalent to the target volume grid for each of the preset selection instructions; and
a first execution subunit configured to take the preset selection instruction as the target selection instruction if the matching volume grid is equivalent to the target volume grid.

In some embodiments, the second determination unit further includes:
a second execution subunit configured to take the preset selection instruction as a first instruction if the matching volume grid is properly included in the target volume grid;
a second determination subunit configured to determine a second instruction in the preset selection instruction according to the matching features corresponding to the selection conditions, wherein a set of matching volume grids corresponding to the second instruction and matching volume grids corresponding to the first instruction is equivalent to a set of the target volume grids; and
a third execution subunit configured to take the first instruction and the second instruction as the target selection instruction.

In some embodiments, the target model is a tubular model, the target volume grid is an outer surface volume grid, and the first determination module includes:
a second execution unit configured to take the surface grid on the outer surface of the tubular model as the similar feature corresponding to the outer surface volume grid; and
the first selection module includes:
a first selection unit configured to select the volume grids where the outer surface volume grids are located to obtain the volume grid set.

In some embodiments, the first selection module includes:
a third determination unit configured to determine the volume grid where the similar feature is located for each of the similar features; and
a second selection unit configured to select all the volume grids to obtain the volume grid set.

In some embodiments, the operation instruction is a delete instruction, and the first receiving module includes:
a first delete unit configured to delete the volume grids included in the volume grid set.

It should be noted here that the above modules are the same as examples and application scenarios embodied by the corresponding steps, but are not limited to the contents disclosed in the above embodiments. It should be noted that, as a part of the device, the above modules can be embodied by software or hardware. A hardware environment includes a network environment.

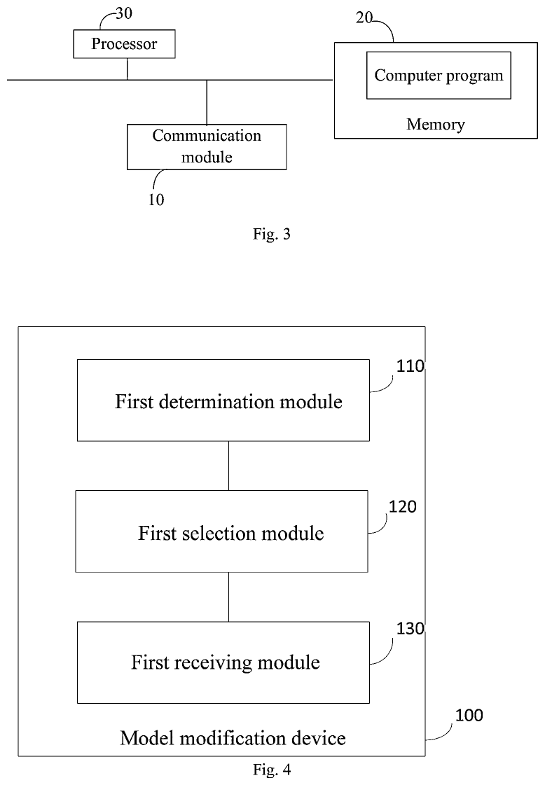

Referring to FIG. 3, the electronic device may include a communication module 10, a memory 20, a processor 30 and the like in hardware structure. In the electronic device, the processor 30 is separately connected with the memory 20 and the communication module 10, and a computer program is stored in the memory 20 and executed by the processor 30, and implements the model modification method of the present disclosure when executed.

The communication module 10 can be connected to an external communication device through network. The communication module 10 can receive requests from the external communication device, and can send requests, instructions and information to the external communication device. The external communication device may be other electronic devices, servers or devices of Internet of things, such as televisions.

The memory 20 may be configured to store software programs and various data. The memory 20 may mainly include a storage program area and a storage data area, wherein the storage program area may store an operation system, an application program required by at least one function (such as determining similar features corresponding to a target volume grid in the target model), and the like. The storage data area may include a database, and may store data or information created according to use of the system. In addition, the memory 20 may include a high-speed random access memory, and a nonvolatile memory, such as at least one disk memory device, a flash memory device, or other nonvolatile solid-state memory devices.

The processor 30, which is a control center of electronic device, connects all parts of the whole electronic device by various interfaces and lines, and performs various functions of the electronic device and processes data by running or executing software programs and/or modules stored in the memory 20 and calling data stored in the memory 20, so as to monitor the electronic device as a whole. The processor 30 may include one or more processing units. In some embodiments, the processor 30 may integrate an application processor and a modem processor, wherein the application processor mainly processes an operation system, a user interface and an application program, and the modem processor mainly processes wireless communication. It can be understood that the above modem processor may not be integrated into the processor 30.

Although not shown in FIG. 3, the electronic device may further include a circuit control module which is configured to connect with a power supply to ensure normal operation of other components. It can be understood by those skilled in the art that the structure of the electronic device shown in FIG. 3 does not constitute a limitation on the electronic device, and may include more or less components than shown, or combine some components, or arrange the components differently.

The present disclosure further provides a readable storage medium on which a computer program is stored. The readable storage medium may be the memory 20 in the electronic device of FIG. 3, or at least one of a ROM (Read-Only Memory)/RAM (Random Access Memory), a magnetic disk, and an optical disk. The readable storage medium includes several instructions for enabling a terminal device with a processor (which may be a TV, an automobile, a mobile phone, a computer, a server, a terminal, a network device, or the like) to execute the methods according to the embodiments of the disclosure.

In the disclosure, the terms “first”, “second”, “third”, “fourth” and “fifth” are only used for the purpose of description, and cannot be understood as indicating or implying relative importance. For those skilled in the art, specific meanings of the above terms in the disclosure can be understood according to specific circumstances.

In description of the specification, description of the terms “an embodiment”, “some embodiments”, “an example”, “a specific example”, “some examples” and the like means that a specific feature, structure, material, or characteristic described in combination with the embodiment or example is included in at least one embodiment or example of the disclosure. In the specification, an illustrative recitation of the above terms does not necessarily refer to the same embodiment or example. Furthermore, the specific feature, structure, material or characteristic described may be combined in any suitable manner in any one or more embodiments or examples. In addition, those skilled in the art can incorporate and combine different embodiments or examples and features of different embodiments or examples described in the specification without contradicting each other.

Although the embodiments of the disclosure have been shown and described above, the protection scope of the disclosure is not limited to this. It can be understood that the above embodiments are exemplary and cannot be understood as limitations on the disclosure. Those skilled in the art may change, modify and substitute the above embodiments within the scope of the disclosure, which shall all be included within the protection scope of the disclosure. Therefore, the protection scope of the disclosure shall be based on the protection scope of the claims.

What is claimed is:

1. A model modification method comprising:
determining similar features corresponding to target volume grids in a target model, wherein each of the similar features is comprised in the corresponding target volume grid;
selecting volume grids associated with the similar features in the target model to obtain a volume grid set, wherein the volume grid set comprises the target volume grids; and
receiving an operation instruction, and executing modification operation corresponding to the operation instruction on the target volume grids in the volume grid set to update the target model.

2. The model modification method according to claim 1, wherein determining similar features corresponding to target volume grids in a target model comprises:
performing feature generating operation on the target model to generate optional features corresponding to the similar features;
acquiring preset selection instructions and determining selection conditions of the preset selection instructions;
determining matching features corresponding to the selection conditions among the optional features for each of the preset selection instructions;
determining a target selection instruction in the preset selection instructions according to the matching features corresponding to the selection conditions; and
executing the target selection instruction to take matching features corresponding to the target volume grids as the similar features.

3. The model modification method according to claim 2, wherein determining a target selection instruction in the preset selection instructions according to the matching features corresponding to the selection conditions comprises:
determining matching volume grids corresponding to the matching features for each of the preset selection instructions;
determining whether the matching volume grid is equivalent to the target volume grid for each of the preset selection instructions; and
when the matching volume grid is equivalent to the target volume grid, taking the preset selection instruction as the target selection instruction.

4. The model modification method according to claim 3, after determining whether the matching volume grid is equivalent to the target volume grid, comprising:
when the matching volume grid comprises the non-target volume grid, taking the preset selection instruction as a non-selection instruction which cannot be selected as the target selection instruction.

5. The model modification method according to claim 3, after determining whether the matching volume grid is equivalent to the target volume grid, comprising:
when the matching volume grid is properly included in the target volume grid, taking the preset selection instruction as a first instruction;
determining a second instruction in the preset selection instruction according to the matching features corresponding to the selection conditions, wherein a set of matching volume grids corresponding to the second instruction and matching volume grids corresponding to the first instruction is equivalent to a set of the target volume grids; and
taking the first instruction and the second instruction as the target selection instruction.

6. The model modification method according to claim 5, wherein determining a second instruction in the preset selection instruction according to the matching features corresponding to the selection conditions comprises:
when there is no preset selection instruction comprising all target volume grids not corresponding to the first instruction, determining a plurality of second instructions, so that a set of matching volume grids corresponding to a plurality of the second instructions and the matching volume grids corresponding to the first instruction is equivalent to the set of the target volume grids.

7. The model modification method according to claim 1, wherein the target model is a tubular model and the target volume grid is an outer surface volume grid, and determining similar features corresponding to the target volume grid in a target model comprises:
taking a surface grid on the outer surface of the tubular model as the similar features corresponding to the outer surface volume grid; and
selecting volume grids associated with the similar features in the target model to obtain a volume grid set comprises:
selecting volume grids where the outer surface volume grids are located to obtain the volume grid set.

8. The model modification method according to claim 1, wherein selecting volume grids associated with the similar features in the target model to obtain a volume grid set comprises:
determining volume grids where the similar features are located for each of the similar features; and
selecting all the volume grids to obtain the volume grid set.

9. The model modification method according to claim 1, wherein the operation instruction comprises a delete instruction, a copy instruction and a move instruction, and executing modification operation corresponding to the operation instruction on the target volume grids in the volume grid set comprises:
deleting, copying or moving the volume grids comprised in the volume grid set.

10. A model modification apparatus, comprising:
a first determination module configured to determine similar features corresponding to target volume grids in a target model, wherein each of the similar features is comprised in the corresponding target volume grid;
a first selection module configured to select volume grids associated with the similar features in the target model to obtain a volume grid set, wherein the volume grid set comprises the target volume grids; and
a first receiving module configured to receive operation instructions and execute modification operation corresponding to the operation instructions on the target volume grids in the volume grid set to update the target model.

11. An electronic device comprising a memory, a processor, and a computer program stored on the memory and capable of running on the processor, wherein the computer program implements the model modification method of claim 1 when executed by the processor.

12. A readable storage medium on which a computer program is stored, wherein the computer program implements the model modification method of claim 1 when executed by a processor.
